(19) United States
(12) Patent Application Publication
(10) Pub. No.: US 2008/0041105 A1
(43) Pub. Date: Feb. 21, 2008

(54) Method of surface modification for the reduction of trace component dissolution

(76) Inventors: Carl Hahn, Sugar Land, TX (US); Daralyn McGuffin, Willis, TX (US); Kurt Ginsel, Conroe, TX (US); Doug Mittlesteadt, Saline, MI (US); Heath Burns, The Woodlands, TX (US); Mathews Thundyil, The Woodlands, TX (US)

Correspondence Address: MARSHALL & MELHORN, LLC, FOUR SEAGATE - EIGHTH FLOOR, TOLEDO, OH, 43604, US

(21) Appl. No.: 11/891,082

(22) Filed: Aug. 9, 2007

Related U.S. Application Data
(60) Provisional application No. 60/837,355, filed on Aug. 11, 2006.

(51) Int. Cl. C03C 17/00

(52) U.S. Cl. 65/31

(57) ABSTRACT

A method or process for reducing the dissolution, or leaching, of trace components from a surface, such as glass, glass fibers, filter media or assembled filters by reaction or adsorption with the surface.

### RELATED APPLICATION

This application is claiming the benefit, under 35 U.S.C. §119(e), of the provisional application filed Aug. 11, 2006 under 35 U.S.C. §111 (b), which was granted Ser. No. 60/837,355. This provisional application is hereby incorporated by reference. Application Ser. No. 60/837,355 is pending as of the filing date of the present application.

### FIELD OF THE INVENTION

The present invention relates generally to a method for reducing the dissolution, or leaching, of trace components from a surface. This invention is particularly advantageous in systems that require very low levels of contaminant (e.g.—electronics and semiconductor processing, medical applications, etc.).

### BACKGROUND OF THE INVENTION

Glass in its various compositions and forms could come into contact with a variety of fluids. These fluids may be used in the medical, semi-conductor, chemical or other industries. In many cases, depending on the fluid in contact with the glass, trace components inherent to the glass will dissolve into the contacting fluid. This is a process commonly referred to as “leaching.” The leaching of trace components may be of concern, if the fluid subsequently encounters processes or systems that are sensitive to these components.

One application of interest pertains to the separation of solid, or discontinuous liquid contaminants from a continuous liquid phase utilizing a porous medium consisting of glass fiber. In this scenario, the continuous liquid phase may leach components from the glass fiber.

In industries that are sensitive to trace contaminants, the problem of extractable contaminants is currently addressed by the use of inert, high purity materials (e.g.—polypropylene, fluoropolymers, etc.). Many of these materials are characterized by sub-optimal performance (e.g.—temperature limitations, chemical compatibility limitations, limitations of fiber size, low filtration capacity for filtration applications) or high price.

It would be advantageous to utilize glass fiber, including borosilicate glass fiber for these applications, due to its superior physical, thermal and chemical properties.

It is known to those skilled in the art that the surface properties of glass (such as surface tension) may be modified in the surface region. This may be accomplished by chemical or physical means. A physical means of modifying the surface involves the coating of a thin layer of material on the surface of the glass, where the thin layer of material is physically attached to the surface without the advantage of a strong chemical bond. A chemical means of modifying the surface involves the reaction of a specific molecule to the functional groups that exist on the surface of the glass. The chemical modification is more resilient when compared to the physical bond, which can “wash off” over time.

These surface modification methods are generally intended to modify surface properties such as zeta potential, interfacial tension etc. This invention introduces a method for surface modification that reduces the dissolution of components from the glass into the surrounding liquid medium.

An application for this method is in the development of low-extractable media for the separation of solids or dispersed liquids from a continuous liquid phase. In order to achieve very high efficiency reduction of particles on the micron and sub-micron scale, conventional high purity materials are processed in such a way as to reduce the media pore size by calendaring a media, which also results in the reduction of media void volume and the subsequent decrease in contaminant capacity. The use of inert fluoropolymers entails high material costs and also results in sub-optimal contaminant capacity.

The current invention allows the use of various media types that normally would suffer from unacceptable dissolution and leaching of trace components in an unmodified state. The benefit of the current invention is that media types may be employed that offer considerable benefits with regard to material cost and performance. For example, unmodified micro-fiber glass media readily outperforms high purity polypropylene and fluoropolymer media in terms of contaminant load at a given particle removal efficiency. However, unmodified micro-fiber glass imparts unacceptably high levels of trace contaminants to the filtrate solution. Trace contaminant dissolution is found in media with binders as well as binder free media.

The surface modification outlined in the current invention allows the use of micro-fiber glass media, maintaining the benefits of high void volume and increased contaminant load, while also imparting very low extractability of trace components.

### RELATED REFERENCES

Multilayer Alkoxysilane Silylation of Oxide Surfaces, Wayne Yoshida, Robert P. Castro, Jeng-Dung Jou, Yoram Cohen, Langmuir, 2001 17, 5882-5888.

Toward Functionalized Surfaces through Surface Esterification of Silica, Gabriel C. Ossenkamp, Tim Kemmitt, Jim H. Johnston, Langmuir, 2002, 18, 5749-5754.

New Approaches to Surface-Alkoxylated Silica with Increased Hydrolytic Stability, Gabriel C. Ossenkamp, Tim Kemmitt, Jim H. Johnston, Chem. Mater. 2001, 13, 3975-3980.

Adsorption Characterization of Oligo(dimethylsiloxane)-Modified Silicas: An Example of Highly Hydrophobic Surfaces with Non-Aliphatic Architecture, Yuri V. Kazakevich, Alexander Y. Fadeev, Langmuir, 2002,18, 3117-3122.

Silanes and Other Coupling Agents, Ed. K. L. Mittal, VSP, 2000.

### DESCRIPTION OF THE PRIOR ART

While a variety of coating types have been applied to glass fibers, the prior art discloses that the surface coatings are applied either to impart a specific physical property to the interface (e.g.—hydrophobicity or hydrophilicity), provide increased adhesion of the fiber to a component or composite matrix, or prevent adhesion of a fluid or fluid component. The object of this invention is to provide a surface barrier at a filter medium that minimizes the dissolution of trace components of the medium. Additionally, various filter media have been treated with coatings as sizing agents for processibility or with coatings as binders. These coatings are varied and include phenolic resins, melamine resins, acrylates, silicones, and others familiar to those skilled in the art. The primary function of these coatings is to enhance either structural integrity of the medium or processibility.

Silanes have been employed extensively for the modification of surfaces. Oxide surfaces react readily with silanes to produce strong, stable surface coatings. The ability to modify silanes with various functional groups allows one to tailor complex surface structures or impart desired chemical and physical properties to an interface. As such, silanes have been employed widely as coupling agents to enhance interfacial surface properties. Silane coupling agents have been employed in paints, coatings and composites to mediate compatibility between the coating and a surface or between glass fiber fillers and the bulk composite matrix. Examples are detailed by Lawton, et al. in U.S. Pat. No. 6,593,255 as well as Schell et al. in U.S. Pat. No. 6,238,791.

Hansen, et al. (U.S. Pat. No. 6,458,436) describe the use of silane surface treatment of vitreous fibers to promote stability in humid environments while retaining fiber dissolution in bodily fluids.

Silane sizing agents have also been applied to glass fiber surfaces for the prevention of alkali attack in concrete compositions. Sizings on alkali resistant glass fibers are described by Gao, et al. in Langmuir, 2003, 19, 2496-2506.

Mao, et. Al. (U.S. Pat. No. 6,844,028) and references therein describe the use of silane surface treatments to create functional films that mediate either specific or non-specific binding of components at a surface.

The use of silanes to generate “siliconized” surfaces has been employed in medical applications to impart a surface that does not bind proteins or other biological macromolecules. Consequently, siliconized surfaces that reduce protein adsorption also reduce hemolysis in blood contact applications. A review of the literature concerning “siliconized” surfaces is provided by Arkles, et al., Chemically Modified Surfaces, Volume 1, Silanes Surfaces and Interfaces, Gordon & Breach Science Publishers, New York, p. 91-105.

Adiletta discloses (U.S. Pat. No. 4,210,697) the use of a fluoropolymer in conjunction with a silicone to treat glass fiber filter media for the preparation of a hydrophobic filter medium.

Various polymeric binders have been applied to glass fibers to impart dimensional stability to the medium as well as desired physical properties, such as hydrophobicity. Taylor, et al. (U.S. Pat. No. 6,884,838) teach that modified polycarboxy polymer binders may be applied to glass fiber mats to provide structural integrity while minimizing water absorption in insulating materials. While many binders have been applied to fiber media, the degree of coating does not provide adequate barrier properties to reduce the dissolution of trace components to acceptable levels in high purity applications.

Examples of coating components employed in this invention are polyalkylenes, polyethers, polyvinyl esters, polyacrylates, ethylene-vinyl acetate copolymers, hydrocarbon waxes, siloxanes, alkylsilanes, alkylsiloxanes and fluorosiloxanes. The invention is not limited to these materials and may also make use of various long chain alcohols at elevated temperature or other chemical species capable of reacting with the surface or physically adsorbing to create an insoluble barrier to dissolution. The integrity or performance of fiber coatings that provide a barrier to dissolution of trace components may be further enhanced by the use of coupling agents.

Examples of coating agents useful in the invention are, but are not limited to: polyalkylenes, polyethers, polyvinyl esters, polyvinyl ethers, ethylene-vinyl acetate copolymers, acrylic polymers, such as polyacrylamide, poly(acrylic acid), poly(methacrylic acid), poly(ethyl acrylate), poly(methyl methacrylate), polyacrylate esters and the like; fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), poly(vinyl fluoride), and the like; polyamides, such as poly(6-aminocaproic acid) or poly(caprolactam), poly(hexamethylene adipamide), poly(hexamethylene sebacamide), poly(11-aminoundecanoic acid), and the like; polyaramides, such as poly(imino-1,3-phenyleneiminoisophthaloyl) or poly(m-phenylene isophthalamide), and the like; polyaryl ethers, such as poly(oxy-2,6-dimethyl-1,4-phenylene) or poly(p-phenylene oxide), and the like; polyaryl sulfones, such as poly(oxy-1,4-phenylenesulfonyl-1,4-phenyleneoxy-1,4-phenylene-isopropylidene-1,4-phenylene), poly-(sulfonyl-1,4-phenyleneoxy-1,4-phenylenesulfonyl-4,4′-biphenylene), and the like; polycarbonates, such as poly(bisphenol A) or poly(carbonyldioxy-1,4-phenyleneisopropylidene-1,4-phenylene), and the like; polyesters, such as poly(ethylene terephthalate), poly(tetramethylene terephthalate), poly(cyclohexylene-1,4-dimethylene terephthalate) or poly(oxymethylene-1,4-cyclohexylenemethyleneoxyterephthaloyl), and the like; polyaryl sulfides, such as poly(p-phenylene sulfide) or poly(thio-1,4-phenylene), and the like; polyimides, such as poly(pyromellitimido-1,4-phenylene), and the like; polyolefins, such as polyethylene, polypropylene, poly(1-butene), poly(2-butene), poly(1-pentene), poly(2-pentene), poly(3-methyl-1-pentene), poly(4-methyl-1-pentene), and the like; vinyl polymers, such as poly(vinyl acetate), poly(vinylidene chloride), poly(vinyl chloride), and the like; polystyrenes; polyurethanes; epoxy resins, Hydrocarbon waxes, alkyl fatty acids (n-Hendecanoic acid, n-Dodecanoic Acid, n-Tridecanoic Acid, n-Tetradecanoic Acid, n-Pentadecanoic Acid, n-Hexadecanoic Acid, n-Heptadecanoic Acid, n-Octadecanoic Acid, n-Nonadecanoic Acid, n-Eicosanoic Acid, n-Heneicosanoic Acid, n-Docosanoic Acid, n-Tricosanoic acid, n-Tetracosanoic Acid, n-Hexacosanoic acid, n-Heptacosanoic Acid, n-Octacosanoic acid, n-Nonacosanoic Acid, n-Triacontanoic acid, n-Hentriacontanoic Acid, n-Dotriacontanoic Acid, n-Tritriacontanoic acid, n-Tetratriacontanoic acid, n-Pentatriacontanoic acid), fatty alcohols (n-octanol, 2-ethylhexanol, n-decanol, lauryl alcohol, Myristyl Alcohol, n-hexadecanol, n-octadecanol, cetyl alcohol, isocetyl alcohol), stearyl alcohol, Oleyl alcohol, and Linoleyl alcohol), silanes (Methyltrichlorosilane, Methylhydrogendichlorosilane, Trimethylchlorosilane, Dimethyldichlorosilane, Ethyltrichlorosilane, Vinyltrichlorosilane, Methylvinyldichlorosilane, Dimethylvinylchlorosilane, Propyltrichlorosilane, Chloropropyltrichlorosilane, Chloroisobutylmethyldichlorosilane, Chloroisobutyldimethylchlorosilane, i-Butyltrichlorosilane, n-Butyltrichlorosilane, t-Butyldimethylchlorosilane, Amyltrichlorosilane, Phenyltrichlorosilane, Phenylmethyldichlorosilane, Diphenydichlorosilane, n-Hexyltrichlorosilane, n-Octyltrichlorosilane, n-Octyldimethylchlorosilane, n-Octadecyldimethylchlorosilane, Trimethylmethoxysilane, Trimethylphenoxysilane, Methyltrimethoxysilane, Methyltriethoxysilane, Methyltriphenoxysilane, Dimethyldimethoxysilane, Dimethyldimethoxysilane, Dimethyldiethoxysilane, Ethyltrimethoxysilane, Ethyltriethoxysilane, Methyl & ethyl triacetoxysilane, Propyltrimethoxysilane, Propyltriethoxysilane, Diisopropyldimethoxysilane, Diisobutyldimethoxysilane, Chloropropyltrimethoxysilane, Chloropropyltriethoxysilane, Chloropropylmethyldimethoxysilane, Chloroisobutylmethyldimethoxysilane, 1,3-dichlorotetramethyldisiloxane, 1,5-dichlorohexamethyltrisiloxane, 1,7-dichlorooctamethyltetrasiloxane, Trifluoropropyltrimethoxysilane, Trifluoropropylmethyldimethoxysilane, i-Butyltrimethoxysilane, n-Butyltrimethoxysilane, n-Butylmethyldimethoxysilane, Phenyltrimethoxysilane, Phenyltriethoxysilane, Phenylmethyldimethoxysilane, Triphenylsilanol, n-Hexyltrimethoxysilane, n-Hexyltriethoxysilane, Diphenyidimethoxysilane, Diphenyldiethoxysilane, n-Octyltrimethoxysilane, Decyltrimethoxysilane, Cyclohexylmethyldimethoxysilane, Cyclohexylethyldimethoxysilane, Dicyclopentyldimethoxysilane, t-Butylethyldimethoxysilane, t-Butylpropyldimethoxysilane, Dicyclohexyldimethoxysilane, i-Butyltrimethoxysilane, i-Butyltriethoxysilane, i-Octyltrimethoxysilane, n-Octyltriethoxysilane, Methyltrimethoxysilane, Vinyltriethoxysilane, Vinyltriacetoxysilane, Methylvinyldimethoxysilane, Allyltrimethoxysilane, Hexenyltrimethoxysilane, Trimethylsilylated trimethylol propane, Hexamethyid isilazane, Tetramethyldivinyidisilazane, (3-(2-Aminoethyl)amino)propyl, methyl silsesquioxanes, methoxy-terminated, Sodium methyl siliconate, Potassium methyl siliconate, i-Butyltrimethoxysilane, i-Butyltriethoxysilane, i-Octyltrimethoxysilane, n-Octyltriethoxysilane, Bis(triethoxysilyl)ethane, alkyl silanes, alkyl siloxanes, arylsilanes, arylsiloxanes), Mercaptopropyltrimethoxysilane, Mercaptopropyltriethoxysilane, Mercaptopropylmethyidimethoxysilane, Bis(triethoxysilylpropyl)disulfide, Bis(triethoxysilylpropyl)tetrasulfide, Aminopropyltrimethoxysilane, Aminopropyltriethoxysilane, Aminopropylmethyldiethoxysilane, m-Aminophenyltrimethoxysilane, Phenylaminopropyltrimethoxysilane, 1,1,2,4-Tetramethyl-1-sila-2-azacyclopentane, Aminoethylaminopropyltrimethoxysilane, Aminoethylaminopropyltriethoxysilane, Aminoethylaminopropylmethyldimethoxysilane, Aminoethylaminopropyltrimethoxysilane hydrolyzate, Aminoethylaminoisobutylmethyldimethoxysilane, Aminoethylaminoisobutylmethyldimethoxysilane hydrolyzate, Trimethoxysilylpropyldiethylenetriamine, Vinylbenzylethylenediaminepropyltrimethoxysilane, Benzylethylenediaminepropyltrimethoxysilane, Allylethylenediaminepropyltrimethoxysilane monohydrochloride, (Triethoxysilylpropyl)urea, Glycidoxypropyltrimethoxysilane, Glycidoxypropyltriethoxysilane, Glycidoxypropylmethyldimethoxysilane, Glycidoxypropylmethyldiethoxysilane, Epoxycyclohexylethyltrimethoxysilane, Epoxysilane-modified melamine, Methacryloxypropyltrimethoxysilane, Acryloxypropyltrimethoxysilane, silicones and mixtures thereof.

The coating components may be applied either neat or as a solution or dispersion in a suitable solvent. The coatings may also be applied in the vapor phase or as a melt. The coating compounds may be applied either sequentially or as a mixture of components.

### SUMMARY OF THE INVENTION

The present invention provides a method for coating glass surfaces with the objective of minimizing the leaching of trace components from the gas into contacting liquid phase. The coating may be a physical adsorption or a chemical bond to the molecules of the glass surface. The coating must be sufficiently free of defects as to adequately address the leaching of trace components into the contacting liquid phase.

Specifically, this invention relates to the coating of glass micro-fibers utilized in filter media. More particularly, the method consists of chemically reacting with the surface to create an insoluble barrier to dissolution. The integrity or performance of fiber coatings that provide a barrier to dissolution of trace components may be further enhanced by the use of coupling agents. This defect-free coating thus enables the use of these high efficiency and high capacity media to be utilized in high purity applications, where the leaching of trace components were previously a barrier to utilization.

Thus, one of the objects of the present invention is to overcome the shortcomings of conventional polymeric or fluoropolymeric media that are used in high purity applications for the removal of contaminants from a continuous liquid stream.

### DESCRIPTION OF THE PREFERRED EMBODIMENT

The preferred embodiment of the invention applies an organo- or fluorosilane to a glass, glass micro-fiber, filtration media or assembled filter imparting decreased tendency to solubilize trace components in the process fluid. The most preferred embodiment makes use of a silane or silanes that are capable of forming a crosslinked, multi-layer surface film that is chemically reacted to the glass, glass micro-fiber, or filtration media. The preferred silanes are chosen from the following: Methyltrichlorosilane, Methylhydrogendichlorosilane, Trimethylchlorosilane, Dimethyldichlorosilane, Ethyltrichlorosilane, Vinyltrichlorosilane, Methylvinyldichlorosilane, Dimethylvinylchlorosilane, Propyltrichlorosilane, Chloropropyltrichlorosilane, Chloroisobutylmethyldichlorosilane, Chloroisobutyldimethylchlorosilane, i-Butyltrichlorosilane, n-Butyltrichlorosilane, t-Butyldimethylchlorosilane, Amyltrichlorosilane, Phenyltrichlorosilane, Phenylmethyldichlorosilane, Diphenyldichlorosilane, n-Hexyltrichlorosilane, n-Octyltrichlorosilane, n-Octyldimethylchlorosilane, n-Octadecyldimethylchlorosilane, Trimethylmethoxysilane, Trimethylphenoxysilane, Methyltrimethoxysilane, Methyltriethoxysilane, Methyltriphenoxysilane, Dimethyidimethoxysilane, Dimethyldimethoxysilane, Dimethyidiethoxysilane, Ethyltrimethoxysilane, Ethyltriethoxysilane, Methyl & ethyl triacetoxysilane, Propyltrimethoxysilane, Propyltriethoxysilane, Diisopropyldimethoxysilane, Diisobutyldimethoxysilane, Chloropropyltrimethoxysilane, Chloropropyltriethoxysilane, Chloropropylmethyldimethoxysilane, Chloroisobutylmethyldimethoxysilane, 1,3-dichlorotetramethyldisiloxane, 1,5-dichlorohexamethyltrisiloxane, 1,7-dichlorooctamethyltetrasiloxane, Trifluoropropyltrimethoxysilane, Trifluoropropylmethyidimethoxysilane, i-Butyltrimethoxysilane, n-Butyltrimethoxysilane, n-Butylmethyldimethoxysilane, Phenyltrimethoxysilane, Phenyltriethoxysilane, Phenylmethyldimethoxysilane, Triphenylsilanol, n-Hexyltrimethoxysilane, n-Hexyltriethoxysilane, Diphenyldimethoxysilane, Diphenyldiethoxysilane, n-Octyltrimethoxysilane, Decyltrimethoxysilane, Cyclohexylmethyldimethoxysilane, Cyclohexylethyldimethoxysilane, Dicyclopentyldimethoxysilane, t-Butylethyldimethoxysilane, t-Butylpropyldimethoxysilane, Dicyclohexyldimethoxysilane, i-Butyltrimethoxysilane, i-Butyltriethoxysilane, i-Octyltrimethoxysilane, n-Octyltriethoxysilane, Methyltrimethoxysilane, Vinyltriethoxysilane, Vinyltriacetoxysilane, Methylvinyldimethoxysilane, Allyltrimethoxysilane, Hexenyltrimethoxysilane, Trimethylsilylated trimethylol propane, Hexamethyldisilazane, Tetramethyldivinyldisilazane, (3-(2-Aminoethyl)amino)propyl, methyl silsesquioxanes, methoxy-terminated, Sodium methyl siliconate, Potassium methyl siliconate, i-Butyltrimethoxysilane, i-Butyltriethoxysilane, i-Octyltrimethoxysilane, n-Octyltriethoxysilane, Bis(triethoxysilyl)ethane, alkyl silanes, alkyl siloxanes, arylsilanes, arylsiloxanes), Mercaptopropyltrimethoxysilane, Mercaptopropyltriethoxysilane, Mercaptopropylmethyldimethoxysilane, Bis(triethoxysilylpropyl)disulfide, Bis(triethoxysilylpropyl)tetrasulfide, Aminopropyltrimethoxysilane, Aminopropyltriethoxysilane, Aminopropylmethyldiethoxysilane, m-Aminophenyltrimethoxysilane, Phenylaminopropyltrimethoxysilane, 1,1,2,4-Tetramethyl-1-sila-2-azacyclopentane, Aminoethylaminopropyltrimethoxysilane, Aminoethylaminopropyltriethoxysilane, Aminoethylaminopropylmethyidimethoxysilane, Aminoethylaminopropyltrimethoxysilane hydrolyzate, Aminoethylaminoisobutylmethyldimethoxysilane, Aminoethylaminoisobutylmethyldimethoxysilane hydrolyzate, Trimethoxysilylpropyidiethylenetriamine, Vinylbenzylethylenediaminepropyltrimethoxysilane, Benzylethylenediaminepropyltrimethoxysilane, Allylethylenediaminepropyltrimethoxysilane monohydrochloride, (Triethoxysilylpropyl)urea, Glycidoxypropyltrimethoxysilane, Glycidoxypropyltriethoxysilane, Glycidoxypropylmethyldimethoxysilane, Glycidoxypropylmethyldiethoxysilane, Epoxycyclohexylethyltrimethoxysilane, Epoxysilane-modified melamine, Methacryloxypropyltrimethoxysilane, Acryloxypropyltrimethoxysilane, silicones and mixtures thereof.

The most preferred embodiment employs a difunctional poly(dimethylsiloxane). The reactive functionality may be a terminal halogen, hydroxyl, acetoxy or alkoxy group. Additionally, the most preferred embodiment may also employ a multi-functional silane such as Bis(triethoxysilyl)ethane. The most preferred embodiment contacts the glass, glass micro-fiber, filter media or assembled filter with an alcoholic solution of the reactive species for a period of time necessary to create the protective surface coating. The glass, glass micro-fiber, filter media or assembled filter may be washed after treatment with a suitable solvent or with de-ionized water to remove residual impurities, and may then be dried.

Experiments

The invention comprises applying a mono-layer or multi-layer surface coating to the filtration media or the assembled filter element in order to limit the solubilization of trace components from the media or filter element. The invention comprises treating the object with a chemical species that reacts with the surface to form a coating or barrier and minimizes the solubilization of trace components into the filtrate.

Examples of coating components employed in the invention are siloxanes, alkylsilanes, alkylsiloxanes and fluorosiloxanes. The invention is not limited to these materials and may also make use of various long chain alcohols or other chemical species capable of reacting with the surface to create a barrier to dissolution.

Surface Treatment:

Prior to surface treatment, the capsule filters were acid washed with aqueous 5% HCl solution followed by two (2) de-ionized (DI) water rinses. For comparison, an un-treated filter was also acid washed with aqueous 5% HCl solution followed by two (2) de-ionized water rinses.

Treatment 1

| | |
|---|---|
| 3.0 grams | Bis(triethoxysilyl)ethane |
| 17.0 grams | n-Octadecyltrichlorosilane |
| 1.0 liter | isopropanol |

To roughly one liter of isopropanol, add 17.0 grams n-Octadecyltrichlorosilane with stirring. Also add 3.0 grams Bis(triethoxysilyl)ethane to the mixture with stirring. Continue stirring for 10 minutes.

Re-circulate the alcoholic silane mixture through the capsule filter for 30 minutes. Drain the capsule filter of residual liquid and blow out the capsule with air or nitrogen. Allow the capsule filter to dry for 24 hours to cure the surface coating. If possible, dry the capsules in a warm oven below the softening point of the polypropylene capsule. After the 24 hour drying, recirculate/rinse the capsule with DI water to remove residual coating agent, alcohol, etc.

Treatment 2

| | |
|---|---|
| 1.0 gram | Bis(triethoxysilyl)ethane |
| 10.0 grams | Aquaphobe CM |
| (Mixture of: | 20-50% 1,3-dichlorotetramethyldisiloxane |
| | 30-60% 1,5-dichlorohexamethyltrisiloxane |
| | 20-50% 1,7-dichlorooctamethyltetrasiloxane) |
| 1.0 liter | isopropanol |

To roughly one liter of isopropanol, add 10.0 grams Aquaphobe CM with stirring. Also add 1.0 gram Bis(triethoxysilyl)ethane to the mixture with stirring. Continue stirring for 10 minutes.

Re-circulate the alcoholic silane mixture through the capsule filter for 30 minutes. Drain the capsule filter of residual liquid and blow out the capsule with air or nitrogen. Allow the capsule filter to dry for 24 hours to cure the surface coating. If possible, dry the capsules in a warm oven below the softening point of the polypropylene capsule. After the 24 hour drying, recirculate/rinse the capsule with DI water to remove residual coating agent, alcohol, etc.

Treatment 3

| | |
|---|---|
| 10.0 grams | Aquaphobe CF (chlorine terminated fluorinated |
| | alkylmethylsiloxane) |
| 1.0 liter | isopropanol |

To roughly one liter of isopropanol, add 10.0 grams Aquaphobe CF with stirring. Continue stirring for 10 minutes.

Re-circulate the alcoholic silane mixture through the capsule filter for 30 minutes. Drain the capsule filter of residual liquid and blow out the capsule with air or nitrogen. Allow the capsule filter to dry for 24 hours to cure the surface coating. If possible, dry the capsules in a warm oven below the softening point of the polypropylene capsule. After the 24 hour drying, recirculate/rinse the capsule with DI water to remove residual coating agent, alcohol, etc.

Evaluation of Treated Media

The treated media is evaluated for performance by filtering a solution of a known particle distribution through the media. Media efficiency is measured by comparing particle counts of the unfiltered solution and the filtered solution. Throughput is determined by the measuring the amount of fluid passed through the filter media before achieving a given differential pressure across the filter.

Dissolution of trace components from the filter or media is determined by analyzing the unfiltered solution as well as the filtered solutions for various trace components by the method of Inductively Coupled Plasma (ICP) analysis.

Trace Component Dissolution & Analysis:

For the purpose of analysis, the trace components of interest are: Aluminum, Boron, Calcium, Chloride, Chromium, Cobalt, Copper, Iron, Magnesium, Manganese, Nickel, Potassium, Sodium, Titanium and Zinc.

| | | Filtered | Filtered | Filtered Solution |
|---|---|---|---|---|
| | Unfiltered | Solution | Solution | Un-Treated |
| | Solution | Treatment 1 | Treatment 3 | Media |
| Analyte | (PPM) | (PPM) | (PPM) | (PPM) |
| Aluminum | <54 | 135 | 117 | 1,930 |
| Boron | 165 | 428 | 939 | 5,630 |
| Calcium | 1,040 | 1,110 | 1,780 | 4,120 |
| Chloride | 77 | 20,000 | 17,900 | 2,150,000 |
| Chromium | 27 | 12 | 12 | 59 |
| Cobalt | <6 | <6 | <6 | <12 |
| Copper | 209 | <20 | <20 | 62 |
| Iron | 249 | 110 | 85 | 409 |
| Magnesium | 98 | 86 | 93 | 401 |
| Manganese | <20 | <20 | <20 | <40 |
| Nickel | 82 | <10 | <10 | <20 |
| Potassium | 5,322,000 | 3,430,000 | 3,500,000 | 4,820,000 |
| Sodium | 13,800 | 10,100 | 13,000 | 61,500 |
| Titanium | <6 | <6 | <6 | 45 |
| Zinc | 78 | 490 | 960 | 5,040 |

We claim:

1. Process for surface treating of glass to reduce the dissolution of components in the glass into a surrounding liquid medium comprising the steps of:
a) applying an organosilane to the glass.

2. Process for surface treating of glass to reduce the dissolution of components in the glass into a surrounding liquid medium comprising the steps of:
a) applying a flurosilane to the glass.

3. Process for surface treating of glass micro-fibers to reduce the dissolution of components in the glass micro-fibers into a surrounding liquid medium comprising the steps of:
a) applying an organosilane to the glass micro-fibers.

4. Process for surface treating of glass micro-fibers to reduce the dissolution of components in the glass micro-fibers into a surrounding liquid medium comprising the steps of:
a) applying a flurosilane to the glass micro-fibers.

5. Process for surface treating of a filtration media to reduce the dissolution of components in the filtration media into a surrounding liquid medium comprising the steps of:
a) applying an organosilane to the filtration media.

6. Process for surface treating of a filtration media to reduce the dissolution of components in the filtration media into a surrounding liquid medium comprising the steps of:
a) applying a flurosilane to the filtration media.

7. Process for surface treating of an assembled filter to reduce the dissolution of components in the assembled filter into a surrounding liquid medium comprising the steps of:
a) applying an organosilane to the assembled filter.

8. Process for surface treating of an assembled filter to reduce the dissolution of components in the assembled filter into a surrounding liquid medium comprising the steps of:
a) applying a flurosilane to the assembled filter.

9. The process defined in any one of claims 1, 3, 5 or 7, wherein the organosilane used is one capable of forming a cross-linked surface film that is chemically reacted to the glass, glass micro-fiber, filtration media or assembled filter.

10. The process defined in any one of claims 2, 4, 6 or 8, wherein the flurosilane used is one capable of forming a cross-linked surface film that is chemically reacted to the glass, glass micro-fiber, filtration media or assembled filter.

11. The process defined in claim 1 comprising:
a) washing the glass to remove residual impurities; and
b) drying the glass.

12. The process defined in claim 2 comprising:
a) washing the glass to remove residual impurities; and
b) drying the glass.

13. The process defined in claim 3 comprising:
a) washing the micro-fiber to remove residual impurities; and
b) drying the micro-fiber.

14. The process defined in claim 4 comprising:
a) washing the micro-fiber to remove residual impurities; and
b) drying the micro-fiber.

15. The process defined in claim 5 comprising:
a) washing the filter media to remove residual impurities; and
b) drying the filter media.

16. The process defined in claim 6 comprising:
a) washing the filter media to remove residual impurities; and
b) drying the filter media.

17. The process defined in claim 7 comprising:
a) washing the assembled filter to remove residual impurities; and
b) drying the assembled filter.

18. The process defined in claim 8 comprising:
a) washing the assembled filter to remove residual impurities; and
b) drying the assembled filter.

19. Process for surface treating of glass by adsorption to reduce the dissolution of components in the glass into a surrounding liquid medium comprising the steps of:
a) applying an organosilane to the glass.

20. Process for surface treating of glass by adsorption to reduce the dissolution of components in the glass into a surrounding liquid medium comprising the steps of:
a) applying a flurosilance to the glass.

21. Process for surface treating of glass by reaction to reduce the dissolution of components in the glass into a surrounding liquid medium comprising the steps of:
a) applying an organosilance to the glass, wherein the organosilance is one capable of forming a cross-linked surface film that is chemically reacted to the glass.

22. Process for surface treating of glass by reaction to reduce the dissolution of components in the glass into a surrounding liquid medium comprising the steps of:
a) applying a flurosilance to the glass, wherein the flurosilance is one capable of forming a cross-linked surface film that is chemically reacted to the glass.
